(19) United States
(12) Patent Application Publication
(10) Pub. No.: US 2003/0137397 A1
(43) Pub. Date: Jul. 24, 2003

(54) Power seat theft deterrent system and method of controlling same

(76) Inventor: Andrew R. Daniels, Newmarket (CA)

Correspondence Address: Clark Hill PLC, Suite 3500, 500 Woodward Avenue, Detroit, MI, 48226-3435, US

(21) Appl. No.: 10/323,571

(22) Filed: Dec. 18, 2002

Related U.S. Application Data
(60) Provisional application No. 60/340,259, filed on Dec. 18, 2001.

(51) Int. Cl. H04Q 1/00

(52) U.S. Cl. 340/5.7

(57) ABSTRACT

A theft deterrent system for an automobile includes a power actuator and a control system coupled to the power actuator. The power actuator is configured to move an automobile seat between a first seat position in which the automobile seat restricts access to at least one of the automobile's control, and a second seat position in which the automobile seat allows access to the automobile controls. The control system includes a command input for receiving commands thereon, and is configured to dispose the automobile seat into the first and second seat positions in accordance with the received commands. The control system is configured with a release code, and is also configured to lock the automobile seat in the first position upon receipt of a lock command and to release the automobile seat from the first position upon receipt of a release command corresponding to the release code.

### BACKGROUND OF THE INVENTION

1. Field of the Invention

The present invention relates to an automobile theft deterrent system and method of controlling same. In particular, the present invention relates to a theft deterrent system for an automobile which reduces the likelihood of theft of the automobile by restricting access to the automobile's seating, steering and speed controls.

2. Description of the Related Art

Many theft deterrent systems are currently available for preventing theft of an automobile. One of the most common theft deterrent systems includes a number of sensors disposed within the automobile for monitoring the closure state of the automobile's doors, an electronic control system which monitors the sensor outputs to detect unauthorized access to the automobile, and an audible alarm connected to the control system which provides an audible indication of authorized access.

Although widely sold as original equipment and aftermarket options, the conventional electronic theft deterrent system is relatively easy to disable by simply cutting the power to the control system. Further, the audible alarm is often ignored by passers-by, thereby reducing the effectiveness of the anti-theft system. Consequently, attempts have been made to improve upon the effectiveness of the conventional automobile theft deterrent system.

One such attempt has involved integrating the electronic control system with the automobile's electronics system to prevent operation of the ignition system and/or fuel system in the event that unauthorized access to the automobile is detected. Although such systems are more difficult to defeat, they can render the automobile completely inoperative for the automobile's owner if the electronic control system fails. Further, such systems also add significantly to the manufacturing cost of the automobile, and cannot be easily installed by aftermarket installers.

Another attempt to improve upon the effectiveness of the conventional automobile theft deterrent system includes a lockable steel member which the automobile owner secures to the automobile's steering wheel to thereby prevent thieves from turning the steering wheel. The lockable steel member is significantly less expensive than the conventional electronic automobile theft deterrent system, however they can be easily defeated by simply cutting or removing the steering wheel.

Consequently, there remains a need for a theft deterrent system which reduces the likelihood of theft of an automobile, without significantly increasing the automobile's cost.

### SUMMARY OF THE INVENTION

According to a first aspect of the present invention, there is provided a theft deterrent system for an automobile. The theft deterrent system includes a power actuator and a control system coupled to the power actuator. The power actuator is configured to move an automobile seat between a first seat position in which the automobile seat restricts access to at least one of the automobile's control, and a second seat position in which the automobile seat allows access to the automobile controls. The control system includes a command input for receiving commands thereon, and is configured to dispose the automobile seat into the first and second seat positions in accordance with the received commands.

In accordance with a preferred implementation of the invention, the control system is configured with an access code, and is also configured to lock the automobile seat in the first position upon receipt of a lock command and to release the automobile seat from the first position upon receipt of a release command corresponding to the access code. In addition, the automobile seat includes a seat mounting frame having mounting points for securing the automobile seat within the automobile, and the automobile seat restricts access to the mounting points when in the first position.

According to a second aspect of the present invention, there is provided an automobile theft deterrent system which includes a power actuator for controlling movement of an automobile seat, and a control system coupled to the power actuator. The control system includes a command input for receiving commands thereon, and is configured to dispose the automobile seat into a first seat position restricting access to at least one automobile control and to dispose the automobile seat into a second seat position allowing access to the automobile control in accordance with the received commands.

According to a third aspect of the present invention, there is provided an automobile theft deterrent system which includes an automobile seat, and a seat control system. The automobile seat includes a seat mounting frame, a seat cushion and a seat back coupled to the mounting frame, and a power actuator coupled to at least one of the seat cushion and the seat back for controlling movement thereof relative to the mounting frame. The mounting frame includes automobile seat mounting points. The seat control system is coupled to the power actuator and includes a command input for receiving commands thereon, and a memory configured with an access code. The control system is configured to lock the automobile seat (upon receipt of a lock command) into a position in which the automobile seat restricts access to the mounting points, and to release the automobile seat from the locked position upon receipt of a release command corresponding to the access code.

### BRIEF DESCRIPTION OF THE DRAWINGS

The present invention will now be described, by way of example only, with reference to the accompanying drawings, in which:

FIG. 1 is a schematic view of a theft deterrent system according to the present invention, depicting the automobile seat disposed within an automobile in an operating position;

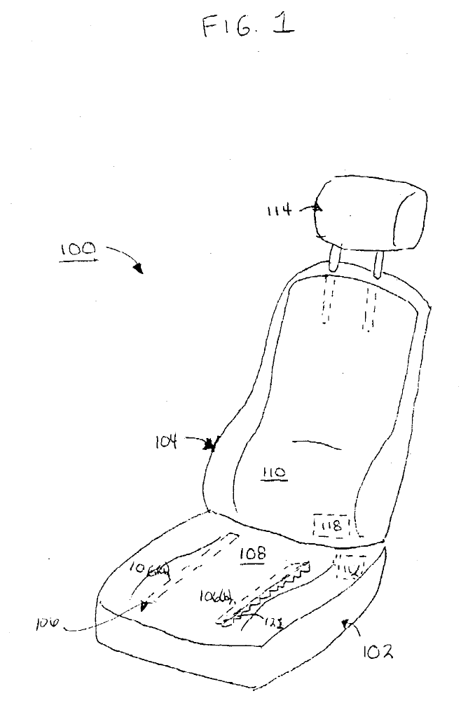

FIG. 2 is a schematic diagram of the power actuator and the control system depicted in FIG. 1; and

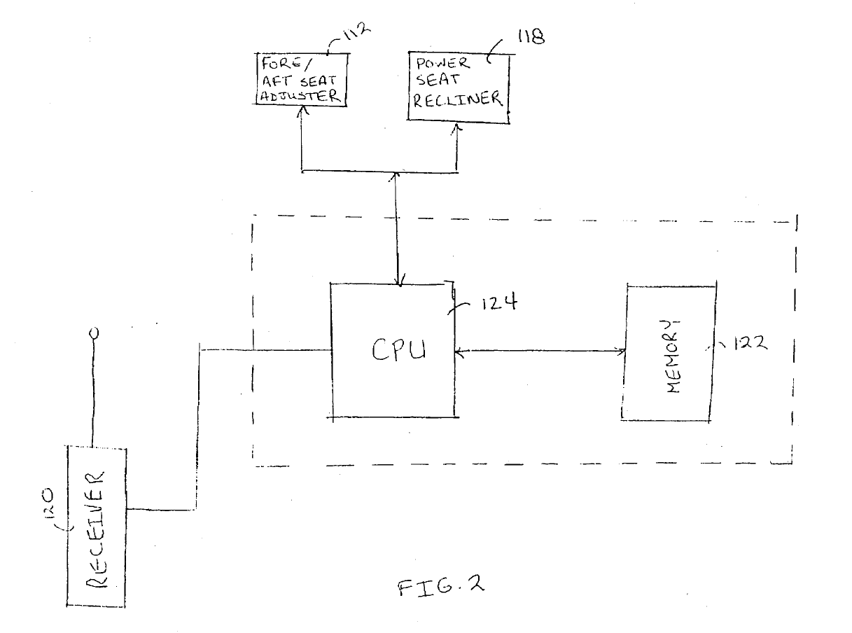

FIG. 3 is a schematic view of the theft deterrent system of FIG. 1 in the lockout position.

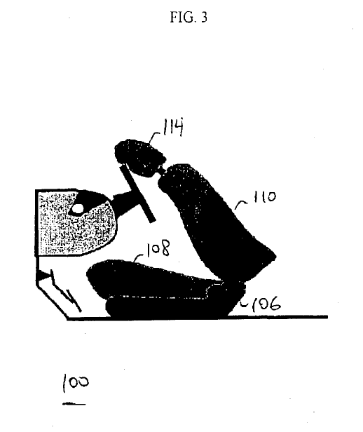

### DETAILED DESCRIPTION OF THE PREFERRED EMBODIMENT

Referring to the drawings, a theft deterrent system, denoted generally as 100, is shown comprising an automobile seat 102, and a seat control system 104. Preferably, the automobile seat 102 is mounted within the automobile in an operating position in which the automobile driver would normally occupy, and includes a seat mounting frame 106, a seat cushion 108, a seat back 110, and a power actuator.

The seat mounting frame 106 comprises a seat track having a pair of rails 106a, 106b. Preferably the seat track is as described in U.S. Pat. Nos. 5,286,076 and 5,741,000. Each rail has mounting points which are used to secure the automobile seat 102 to the automobile. Typically the mounting points comprise apertures, and the seat mounting frame rails 106a, 106b are secured to the automobile by bolts which extend through the apertures into the floor of the automobile.

Preferably, the seat cushion 108 is slidably mounted on the seat mounting frame rails 106, and the seat cushion 108 is configured in such a manner that the seat cushion 108 can move fore and aft along the rails 106 between a driving or operating position and a lockout position. In the driving position, the seat cushion 108 is positioned so as to provide the automobile driver with full access to the brake pedal and the accelerator pedal. In the lockout position, the seat cushion 108 is positioned sufficiently forward of the driving position to cooperate with the steering wheel so as to prevent or at least significantly restrict seating access to the seat cushion 108, and the speed control devices, including the brake pedal, the clutch pedal, the accelerator pedal as well as the mounting frame bolts.

The seat back 110 has a base which is disposed above the seat cushion 108, and is pivotally coupled at its base by a recliner, preferably according to any one of U.S. Pat. Nos. 6,120,098, 6,019,430, and 6,312,053, to the seat cushion 108 to allow the seat back 110 to rotate about its base between a partially reclined position and a forwardly inclined position. As shown, the seat back 110 preferably also includes an adjustable head restraint 114 which is vertically movable between an extended position, vertically spaced above the top of the seat back 110, and a retracted position, seated against the top of the seat back 110. When the seat back 110 is oriented in the partially reclined position, the seat back 110 is angled so as to provide the automobile driver with full access to the steering wheel. When the seat back 110 is oriented in the forwardly inclined position, and the seat cushion 108 is positioned in the lockout position, the seat back 110 is angled sufficiently forwards so as to prevent or at least significantly restrict seating and access to the steering wheel.

The power actuator includes a power fore/aft seat adjuster or actuator assembly 112, and a power seat recliner 118. The power fore/aft seat adjuster 112 comprises a rack gear 121, a prime mover, and a load sensor coupled to the prime mover. The rack gear 121 is secured to one of the rails 106(a), 106(b) of the mounting frame 106 and extends substantially the entire length of the rail. The present embodiment is illustrated with a rack gear, however, it is apparent to those skilled in the art that other drives could be employed to move the seat fore and aft, including a lead screw, as described in U.S. Pat. Nos. 4,966,045 and 5,732,923.

Preferably, the prime mover comprises a DC electric motor powered by the electrical system of the automobile, however other forms of prime movers may also be employed. The prime mover is secured to the seat cushion 108, and includes a pinion which engages the rack gear 121 to thereby drive the seat cushion 108 between the driving position and the lockout position.

Preferably, the pinion is sufficiently small in size relative to the rack gear 121 that the seat cushion 108 cannot be moved manually, and can only be moved when the prime mover is actuated. As will be apparent, the seat cushion 108 will move forwards when the prime mover is commanded to rotate in one direction, and will move aft or rearwards when the prime mover is commanded to rotate in the opposite direction.

The load sensor measures the mechanical load on the prime mover, and is configured to provide the seat control system 104 with an overload signal when the load on the prime mover exceeds a maximum predetermined value. In this manner, the load sensor is able to signal the seat control system 104 if an obstruction is encountered while the seat cushion 108 is being moved between the driving position and the lockout position.

The power seat recliner 118 includes a sector gear disposed within the seat back 110 adjacent the base of the seat back 110, a prime mover or actuator disposed within the seat cushion 108 adjacent the rear portion of the seat cushion 108, and a load sensor coupled to the prime mover. Preferably, the prime mover comprises a DC electric motor powered by the electrical system of the automobile, however other forms of prime movers may also be employed.

The prime mover includes a pinion which engages the sector gear to thereby pivot the seat back 110 between the partially reclined position and the forwardly inclined position. Preferably, the pinion is significantly smaller in size than the sector gear, so that the seat back 110 cannot be moved manually, and can only be moved when the prime mover is actuated. As will be apparent, the seat back 110 will rotate into the partially reclined position when the prime mover is commanded to rotate in one direction, and will pivot into the forwardly inclined position when the prime mover is commanded to rotate in the opposite direction.

The load sensor measures the mechanical load on the prime mover, and is configured to provide the seat control system 104 with an overload signal when the load on the prime mover exceeds a maximum predetermined value. In this manner, the load sensor is able to signal the seat control system 104 if an obstruction is encountered while the seat back 110 is being moved between the partially reclined position and the forwardly inclined position.

The seat control system 104 is electrically coupled to the power seat adjuster 112, and the power seat recliner 118 of the power actuator. Preferably, the seat control system 104 is secured to the automobile, and is disposed in a concealed location which does not readily allow access to the seat control system 104. The seat control system 104 includes a signal receiver, a position sensor, a seat position set switch, and a data processor in communication with the position sensor, the seat position set switch, the prime mover and the obstruction sensor of the power seat adjuster 112, and the prime mover and the obstruction sensor of the power seat recliner 118.

Preferably, the operator of the automobile is provided with a wireless-enabled key fob which is configured with a non-volatile memory 122 having a unique security code, and a signal receiver 120 comprising a wireless signal receiver 120 which is configured to receive user command signals from the wireless-enable key fob. Typically, the remote user commands comprises either a “lockout command” signal which commands the seat control system 104 to move the automobile seat 102 from the driving position into the lockout position, or a “release command” signal which commands the seat control system 104 to move the automobile seat 102 from the lockout position back into the driving position.

Preferably, a data processor actuates the prime mover of the power seat adjuster 112, and the prime mover of the power seat recliner 118 by transmitting electronic pulses to the prime movers. The position sensor comprises an electronic counter coupled to the data processor which counts the transmitted electronic pulses. In this manner, the position sensor is able to provide the data processor with information identifying the angular position of the seat back 110 portion, and information identifying the fore/aft position of the seat cushion 108. Alternatively, the position sensor comprises a potentiometer that correlates output to rotational position.

The data processor comprises a non-volatile electronic memory 122, and a central processing unit 124 electrically coupled to the electronic memory 122. The electronic memory 122 includes an access code uniquely associated with the seat control system 104, a count value associated with the current angular position of the seat back 110, and a count value associated with the current fore/aft position of the seat cushion 108. Until the automobile operator issues a “lockout command”, the data processor monitors the seat position set switch, actuates the power seat adjuster 112 and the power seat recliner 118 accordingly, and updates the associated count values in the electronic memory 122.

The electronic memory 122 also includes processing instructions for the central processing unit, which causes the data processor of the power actuator to operate in the following manner. When the owner of the automobile, wishes to move the automobile seat 102 cushion into the lockout position and the seat back 110 into the forwardly inclined position, the owner transmits a “lockout command” signal to the seat control system 104 using the wireless key fob. The “release command” includes the unique security code encoded in the non-volatile memory 122 of the key fob.

Upon receipt at the signal receiver 120 of the “lockout command” signal, the data processor compares the received security code with the access code stored in the electronic memory 122 of the data processor. If the received security code matches the access code, the data processor copies the count value associated with the partially reclined position of the seat back 110, and the count value associated with the driving position of the seat cushion 108 from the electronic memory 122 of the data processor into the position sensor.

The data processor then ignores the position of the seat position set switch, and provides the power seat recliner 118 with the appropriate directional pulses, thereby causing the power seat recliner 118 to initiate rotation of the seat back 110 from the partially reclined position towards the forwardly inclined position. The data processor also provides the power seat adjuster 112 with the appropriate directional pulses, causing the power seat adjuster 112 to initiate movement of the seat cushion 108 from the driving position towards the lockout position.

The position sensor decrements its count values after each directional pulse applied to the power seat recliner 118 and the power seat adjuster 112. When the position sensor count value for the power seat recliner 118 reaches zero, indicating that the seat back 110 has reached the forwardly inclined position, the data processor discontinues applying pulses to the power seat recliner 118, thereby terminating further rotation of the seat back 110. Similarly, when the position sensor count value for the power seat adjuster 112 reaches zero, indicating that the seat cushion 108 has reached the lockout position, the data processor discontinues applying pulses to the power seat adjuster 112, thereby terminating further movement of the seat cushion 108.

At this point, the seat cushion 108 is positioned sufficiently forwards of the driving position so as to prevent or at least significantly restrict access to the brake pedal, the accelerator pedal and the bolts of the mounting frame 106. Further, the seat back 110 is angled sufficiently forwards so as to prevent or at least significantly restrict a person from sitting on the seat cushion 108 and accessing to the steering wheel.

Until receipt of an authenticated “release command”, as described below, the data processor continues to ignore the position of the seat position set switch, thereby preventing movement of the automobile seat 102 under electrical power. Further, in view of the relative sizes of the prime mover pinion and the sector gear of the power seat recliner 118, and the relative sizes of the prime mover pinion and the rack gear 121 of the power seat adjuster 112, the automobile seat 102 cannot be moved manually so at allow unauthorized access to the automobile's controls.

If at any time during movement of the automobile seat 102, either the load sensor of the power seat recliner 118 or the load sensor of the power seat adjuster 112 signals the data processor that an obstruction has been encountered, the data processor immediately discontinues applying pulses to the power seat recliner 118 and the power seat adjuster 112, thereby terminating further movement of the automobile seat 102.

When the owner of the automobile, wishes to move the automobile seat cushion 102 into the driving position and the seat back 110 into the partially reclined position, the owner transmits a “release command” signal to the seat control system 104 using the wireless key fob. The “release command” includes the unique security code encoded in the non-volatile memory 122 of the key fob. The “release command” can be coupled with the “unlock command” currently employed on vehicles.

Upon receipt at the signal receiver 120 of the “release command” signal, the data processor attempts to authenticate the command by comparing the security code included with the command against the access code stored in the electronic memory 122 of the data processor. If the received security code matches the access code, the data processor copies the count value associated with the partially reclined position of the seat back 110, and the count value associated with the driving position of the seat cushion 108 from the electronic memory 122 of the data processor into the position sensor. The data processor then provides the power seat recliner 118 with the appropriate directional pulses, thereby causing the power seat recliner 118 to initiate rotation of the seat back 110 from the forwardly inclined position towards the partially reclined position. The data processor also provides the power seat adjuster 112 with the appropriate directional pulses, causing the power seat adjuster 112 to initiate movement of the seat cushion 108 from the lockout position towards the driving position.

The position sensor decrements its count values after each directional pulse applied to the power seat recliner 118 and the power seat adjuster 112. When the position sensor count value for the power seat recliner 118 reaches zero, indicating that the seat back 110 has reached the partially reclined position, the data processor discontinues applying pulses to the power seat recliner 118, thereby terminating further rotation of the seat back 110. Similarly, when the position sensor count value for the power seat adjuster 112 reaches zero, indicating that the seat cushion 108 has reached the driving position, the data processor discontinues applying pulses to the power seat adjuster 112, thereby terminating further movement of the seat cushion 108.

At this point, the automobile seat 102 will be restored to its original position, prior to the initiation of the “lockout command”, thereby providing full access to the steering wheel, the brake pedal and the accelerator pedal. Further, at this point, the data processor begins to monitor the position of the seat position set switch, thereby allowing the automobile seat 102 to be moved again under electrical power.

As above, if at any time during movement of the automobile seat 102, either the load sensor of the power seat recliner 118 or the load sensor of the power seat adjuster 112 signals the data processor that an obstruction has been encountered, the data processor immediately discontinues applying pulses to the power seat recliner 118 and the power seat adjuster 112, thereby terminating further movement of the automobile seat 102.

The present invention is defined by the claims appended hereto, with the foregoing description being illustrative of a preferred embodiment of the present invention. Those of ordinary skill may envisage certain additions, deletions and/or modifications to the described embodiment, which although not explicitly described herein, do not depart from the scope of the invention, as defined by the appended claims.

What is claimed is:

1. A theft deterrent system for an automobile comprising:
a power actuator engaging an automobile seat to move the automobile seat between a lockout position in which the automobile seat moves forwardly cooperating with a steering wheel of the automobile restricting seating access to the automobile seat and an operating position in which the automobile seat moves rearwardly allowing seating access; and
a control system coupled to the power actuator and including a command input for receiving commands thereon, the control system being configured to dispose the automobile seat into the lockout and operating positions in accordance with the received commands.

2. The theft deterrent system according to claim 1, wherein the control system is configured with a release code, and is configured to responsively move the automobile seat to the lockout position upon receipt of a lock command and to responsively move the automobile seat from the lockout position to the operating position upon receipt of a release command corresponding to the release code.

3. The theft deterrent system according to claim 2, wherein the automobile seat includes a seat mounting frame having mounting points for securing the automobile seat within the automobile, and the automobile seat restricts access to the mounting points in the lockout position.

4. The theft deterrent system according to claim 3, wherein the control system includes a memory configured with the release code.

5. The theft deterrent system according to claim 4, further comprising:
an automobile seat including a seat track, a seat cushion mounted on the seat track, and a seat back coupled to the seat cushion, a recliner actuator coupled between the seat cushion and the seat back effecting relative movement therebetween, a fore/aft actuator coupled between members of the seat track for effecting fore/aft movement of the automobile seat, the seat track having automobile seat mounting points; and
a seat control system coupled to the recliner actuator and the fore/aft actuator and including a command input for receiving commands thereon, and a memory configured with a release code, the control system being configured to move the automobile seat, upon receipt of a lock command, into a lockout position in which the automobile seat and seat back move forwardly cooperating with a steering wheel of the automobile restricting seating access to the automobile seat and to move the automobile seat, upon receipt of a release command corresponding to the release code, to an operating position in which the automobile seat and seat back move rearwardly allowing seating access the automobile seat.
